(19) United States
(12) Patent Application Publication
(10) Pub. No.: US 2005/0177714 A1
(43) Pub. Date: Aug. 11, 2005

(54) Authentication method of data processing apparatus with recording device and apparatus for the same

(75) Inventors: Seung-youl Jeong, Hwaseong-si (KR); Jong-lak Park, Suwon-si (KR); Sung-youn Cho, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/983,589

(22) Filed: Nov. 9, 2004

(30) Foreign Application Priority Data
Feb. 16, 2004 (KR) 2004-9948
Feb. 10, 2004 (KR) 2004-8641

(51) Int. Cl. G11B 15/12

(52) U.S. Cl. 713/155

(57) ABSTRACT

An apparatus for and a method of authenticating access of a data recording device to data provided by a host system. First and second random numbers are generated and exchanged by the host system and the recording device. An ID of the recording device stored by the host system and an ID of the host system stored by the recording device are each encrypted by the first and second random numbers. The encrypted IDs are exchanged by the host system and the recording device and respectively decrypted by the first and second random numbers. If the ID decrypted by the recording device matches the stored ID of the host system, the host system is authenticated at the recording device. If the ID decrypted by the host system matches the stored ID of the recording device, the recording device is authenticated at the host system.

### CROSS-REFERENCE TO RELATED APPLICATIONS

This application claims the benefit of Korean Patent Application No. 2004-8641, filed on Feb. 10, 2004, in the Korean Intellectual Property Office, the disclosure of which is incorporated herein by reference.

### BACKGROUND OF THE INVENTION

1. Field of the Invention

The present invention relates to a data processing apparatus with a recording medium for storing data processed by a host system, and more particularly, to a method of authentication which determines legality of a recording device for accessing to the host system and an apparatus for the same.

2. Description of the Related Art

Examples of an image signal receiving apparatus provided with recording media for storing image signals include a set-top box (STB) having a hard disk drive (HDD), a CD recording device or a DVD recording device, a personal video recorder (PVR), a monitor, a personal computer (PC), a video cassette recorder (VCR), and the like.

The STB may be used for a video on demand (VOD) service. The VOD service is not a one-sided method in which a data stream is transferred from a broadcast station to a user, but the VOD service allows a user to directly select content stored in a media database (MDB) to watch a selected program at any time. A basic system for the VOD service includes a video source system provided with a video server, a subscriber's terminal such as an STB, and a network.

FIG. 1 illustrates a configuration of a general VOD service. The VOD service is provided using at least one MDB 102, at least one video server 104, a basic communication network 106, a subscriber network 108, a STB 110, and the like. Each video server 104 performs the following functions: receiving, processing and managing a user's request, 2) storing large amounts of digital video data, managing multiple inputs and outputs, managing one or databases, and recovering faults. The STB 110 performs the following functions: connecting a user to a subscriber network, decompressing compressed video data, and providing security and reservation services.

An STB for recording VOD service data is disclosed in Korea Patent Laid-Open Publication No. 19974852 (Jan. 29, 1997). According to the Korea Patent Laid-Open Publication No. 19974852, the STB stores the VOD service data provided from a service provider on an HDD and allows a user to replay the VOD service data stored on the HDD at a convenient time after finishing communication.

FIG. 2 illustrates an exemplary STB provided with an HDD. The STB 200 shown in FIG. 2 includes a system controller 204, an interface 206, an MPEG decoder 208, a digital-to-analog converter (DAC) 210 and an HDD 212. The system controller 204 controls operation of the STB 200 of FIG. 2 according to a user control command received through a remote controller receiver 202. The interface 206 connects to a video server 104 shown in FIG. 1 under control of the system controller 204. The MPEG decoder 208 decodes MPEG-compressed data transmitted from the video server 104 and restores video and audio data. The DAC 210 converts the restored video and audio data into an analog signal and outputs the converted analog signal through a TV set or a monitor. The HDD 212 stores the MPEG-compressed data transmitted from the video server 104, and/or reproduces the stored MPEG-compressed data to provide the stored MPEG-compressed data to the MPEG decoder 208.

The apparatus shown in FIG. 2 stores the VOD service data provided from the video server 104 on the HDD 212 and allows the user to replay the VOD service data stored on the HDD after finishing communication.

An illegal use protection device and method for the VOD service is disclosed in Korean Patent Laid-Open Publication No. 2002-71268 (Sep. 12, 2002). The invention disclosed in Korean Patent Laid-Open Publication no. 2002-71268 provides a device for and a method of preventing non-members from accessing the VOD service data. That is, persons who are not members of the service and who do not pay an access fee are excluded from benefiting from the VOD service data.

FIG. 3 illustrates a conventional illegal use protection device. FIG. 3 illustrates an illegal use protection device disclosed in Korean Patent Laid-Open Publication No. 2002-71268. The device 300 shown in FIG. 3 includes a user authenticator 302, a controller 304, a media server connector 306, a database 308 and an input unit 310. The user authenticator 302 authenticates a legal user. The controller 304 controls a path between the media server connector 306 and the input unit 310 according to an authentication result of the user authenticator 302.

The illegal use protection device described in Korean Patent Laid-Open Publication No. 2002-71268 prevents the non-members who are not charged from illegally using the service but cannot prevent the non-members from illegally using the legally obtained VOD service data.

Specifically, if the HDD 212 is removable from the STB shown in FIG. 1 or replaceable with another recording medium, the VOD service data stored on the HDD 212 may be illegally used.

Some VOD services maintain the VOD service data stored on the HDD 212 for a predetermined period and then automatically delete the data so that the contents are prevented from being illegally used but these methods are not useful in case the HDD 212 is removed from the STB or replaced with another recording medium.

FIG. 4 illustrates an authentication method of the related art. In the authentication method shown in FIG. 4, an HDD compares a self (own) identifier (ID) (ID) with an ID transmitted from a host system. If the self ID and the transmitted ID match each other, the HDD transmits an authentication success message to the host system. Then, the host system receives the authentication success message from the HDD and allows the HDD to be accessed.

In the authentication method of the related art shown in FIG. 1, the host system transmits the ID to the HDD whenever authentication is performed. Since this ID is determined beforehand and maintained to be constant, if an unauthorized user reads out the information transmitted between the host system and the HDD or acquires the ID by any other method, the security of the HDD is compromised.

Meanwhile, since only the HDD authenticates the host system, if the unauthorized user connects to the host system, and the HDD is programmed to send an authentication success message for any authentication request sent from the host system to the HDD, the host system recognizes the access from the HDD as an access from the legal HDD and allows the HDD to access the host system. Therefore, the important information and the chargeable information transmitted through the host system can be stored and used on the illegal HDD.

### SUMMARY OF THE INVENTION

The present invention provides a method of authenticating access of a data processing apparatus to a source of data, such as a recording medium, thus preventing an unauthorized data processing apparatus from accessing the data.

The present invention provides an authentication apparatus suitable for the implementing the authentication method.

The present invention provides a recording medium for storing a program suitable for performing the authentication method.

According to an aspect of the present invention, there is provided an authentication method of a host system and a data processing apparatus, the host system processing data, the data processing apparatus being provided with a recording device which accesses to the host system, the method comprising: generating a first random number and a second random number at the host system and the recording device, respectively; transmitting the first and second random numbers from the host system and the recording device to the recording device and the host system respectively; encrypting a common ID (identifier) for the host system and the recording device by the first random number at the host system to transmit the encrypted ID to the recording device, and encrypting the common ID by the second random number at the recording device to transmit the encrypted ID to the host system; and decrypting the encrypted ID transmitted from the recording device at the host system, decrypting the encrypted ID transmitted from the host system at the recording device, comparing the common ID decrypted by the host system with an common ID of the host system to check whether the decrypted ID is identical to the common ID of the host system, comparing the common ID decrypted by the recording device with the common ID of the recording device to check whether the decrypted ID is identical to the common ID of the recording device, if the common ID decrypted by the host system is identical to the common ID of the host system, authenticating the recording device at the host system, and if the common ID decrypted by the recording device is identical to the common ID of the recording devices, authenticating the host system at the recording devices.

According to another aspect of the present invention, there is provided an authentication system of a host system and a data processing apparatus, the host system processing data, the data processing apparatus being provided with a recording device which accesses to the host system, the system comprising: a first authentication apparatus provided in the host system; and a second authentication apparatus provided in the recording device, wherein the first authentication apparatus comprises: a first random number generator which generates a first random number; a first secret key encryptor which encrypts a common ID for the host system and the recording device by the first random number and a second random number and/or decrypts an encrypted ID transmitted from the recording device by the first random number and the second random number; and a first authentication controller which controls the first random number generator to generate the first random number and transmit the first random number to the recording device at the recording device's request for an access, if the second random number is transmitted from the recording device, then controls the first secret key encryptor to generate an encrypted ID and transmit the encrypted ID to the recording device, if the encrypted ID is transmitted from the recording device, then controls the first secret key encryptor to decrypt the encrypted ID, and if the decrypted ID is identical to the common ID, then authenticates the recording device, and wherein the second authentication apparatus comprises: a second random number generator which generates a second random number; a second secret key encryptor which encrypts a common ID for the host system and the recording device by the first random number and the second random number and/or decrypts the encrypted ID transmitted from the host system by the first random number and the second random number; and a second authentication controller which controls the second random number generator to generate the second random number and transmit the second random number to the host system at the host system's request for an authentication, if the first random number is transmitted from the host system, then controls the second secret key encryptor to generate an encrypted ID and transmit the encrypted ID to the host system, if the encrypted ID is transmitted from the host system, then controls the second secret key encryptor to decrypt the encrypted ID, and if the decrypted ID is identical to the common ID, then authenticates the host system.

According to another aspect of the present invention, there is provided a computer readable recording medium storing a program of an authentication method a host system and a data processing apparatus, the host system processing data, the data processing apparatus being provided with a recording device which accesses to the host system, wherein the program comprises: generating a first random number and a second random number at the host system and the recording devices respectively; transmitting the first and second random numbers from the host system and the recording devices to the recording devices and the host system respectively; encrypting a common ID (identifier) for the host system and the recording devices by the first random number at the host system to transmit the encrypted ID to the recording devices, and encrypting the common ID by the second random number at the recording devices to transmit the encrypted ID to the host system; and decrypting the encrypted ID transmitted from the recording devices at the host system, decrypting the encrypted ID transmitted from the host system at the recording devices, comparing the common ID decrypted by the host system with the common ID of the host system to check whether the decrypted ID is identical to the common ID of the host system, comparing the common ID decrypted by the recording devices with the common ID of the recording devices to check whether the decrypted ID is identical to the common ID of the recording devices, if the common ID decrypted by the host system is identical to the common ID of the host system, then authenticating the recording devices at the host system, and if the common ID decrypted by the recording devices is identical to the common ID of the recording devices, then authenticating the host system at the recording devices.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the present invention will become more apparent by describing in detail exemplary embodiments thereof with reference to the attached drawings in which:

FIG. 1 illustrates a configuration of a conventional general VOD service;

FIG. 2 illustrates an exemplary conventional set-top box provided with a hard disc drive;

FIG. 3 illustrates a conventional illegal use protection device;

FIG. 4 illustrates a conventional method of authentication;

FIG. 5 illustrates allocation of IDs and public key encryption keys used in a method of authentication according to an embodiment of the present invention;

FIG. 6 illustrates a method of authentication according to an embodiment of the present invention;

FIG. 7 illustrates triple DES encryption and decryption; and

FIG. 8 is a block diagram illustrating an authentication apparatus according to an embodiment of the present invention.

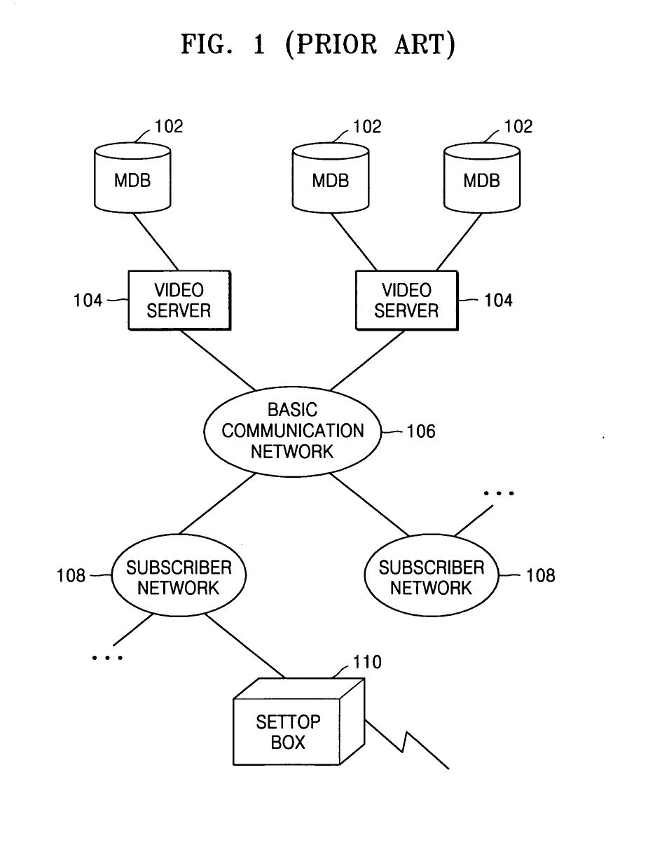

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A data processing apparatus according to the present invention comprises an STB having an HDD, a CD recording device or a DVD recording device, a PVR, a monitor, a PC, a VCR and/or the like.

According to a method of authentication of the present invention, an ID is encrypted using a first random number generated by a host system to transmit the encrypted ID to a recording device, and an the ID is encrypted using a second random number generated by the recording device to transmit the encrypted ID to the host system. Even if the data transmitted between the host system and the recording device is read out between the host system and the recording device, the IDs are prevented from being compromised.

In the authentication method according to the present invention, both a public key encryption method and a secret key encryption method are used. The public key encryption method, for example, RSA (Rivest, Shamir, Adelman), is used to transmit the first random number generated by the host system to the recording device and to transmit the second random number generated by the recording device to the host system. The secret key encryption method is used to transmit the ID allocated commonly to the host system and the recording device by the first random number and the second random number, respectively, to the recording device and the host system, respectively. As described above, the authentication method according to the present invention is more effective to perform authentication since the host system and the recording device transmit the random numbers to each other by the public key encryption method and transmit the IDs to each other by the secret key encryption method.

In the authentication method and apparatus, when the recording device connects to the host system for the first time or when the recording device connected to the host system is booted up for the first time, the IDs may be allocated to the host system and the recording device. The IDs may be common to the host system and the recording device. In addition, when the recording device connects to the host system for the first time or when the recording device connected to the host system is booted up for the first time, the first public key of the host system for public encryption method and the second public key of the recording device may be allocated to the host system and the recording device, respectively.

Alternatively, the IDs of the host system and the recording device may be different as long provided the ID of the host system is known by the recording device and the ID of the recording device is known to the host system and the processing logic is adjusted accordingly.

According to an authentication method and apparatus of the present invention, since data is recordable on only the authenticated recording device and only the data recorded on the authenticated recording device may be replayed, it is not possible to remove the recording device from a first data processing apparatus to use in a second data reproducing apparatus or to replace the recording device in the first data reproducing apparatus with a second recording device to use data from the second recording device. Therefore, the contents are prevented from being illegally used.

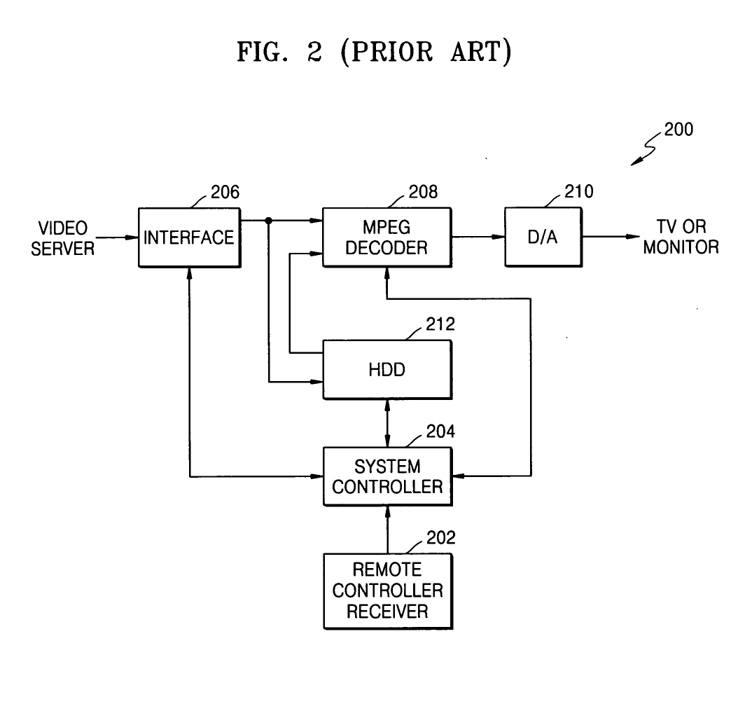

For example, where the authentication method is adopted in an STB shown in FIG. 2, one of a pair of public keys is allocated to the STB and the other is allocated to an HDD. The STB and the HDD are authenticated only using the random numbers generated by the STB and the HDD and the allocated public keys. Therefore, the VOD service data stored on the HDD removed from the STB cannot be replayed by another data processing apparatus and the STB cannot record the VOD service data on another HDD substituted for the original authenticated HDD.

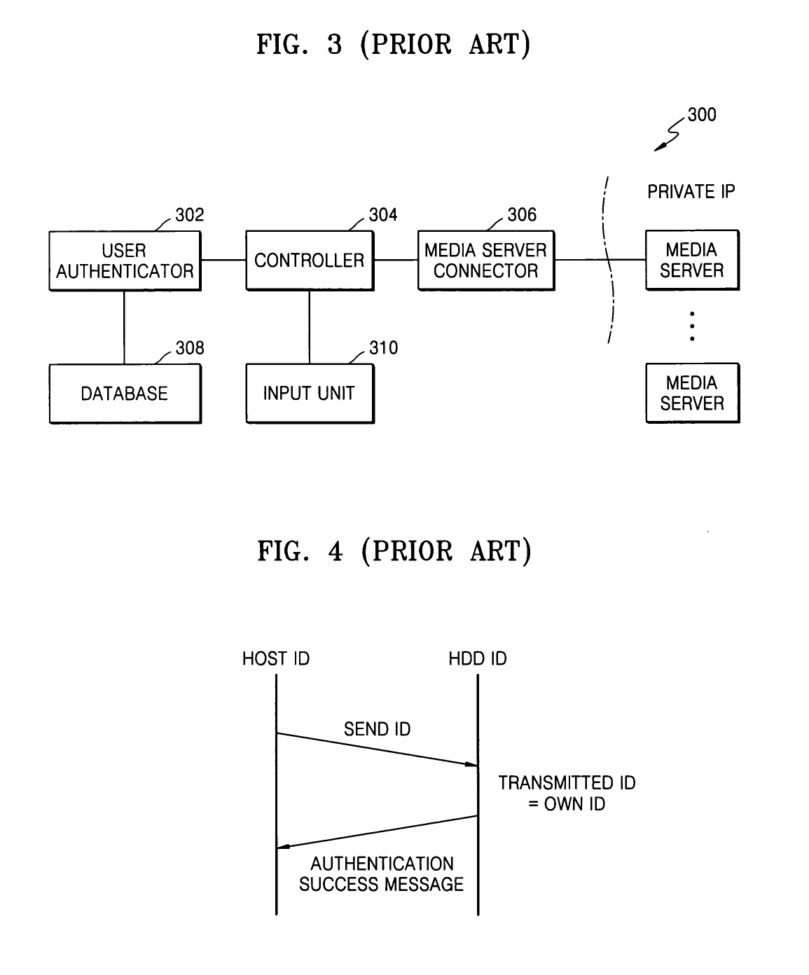

The authentication method of the present invention is useable along with an illegal use protection apparatus, such as described referring to FIG. 3, and prevents the legally obtained VOD service data from being illegally used.

The STB in this embodiment of the present invention is provided with an HDD. The STB according to the present invention may be supplied from a VOD service provider to a subscriber. The VOD service provider may adopt the authentication method according to the present invention so as to prevent the contents recorded on the HDD embedded in the STB from being illegally used. Particularly, one of a pair of keys is allocated to the STB and the other is allocated to the HDD. The STB and the HDD authenticate each other by the pair of keys to allow the VOD service data to be recorded on the HDD according to the authentication result.

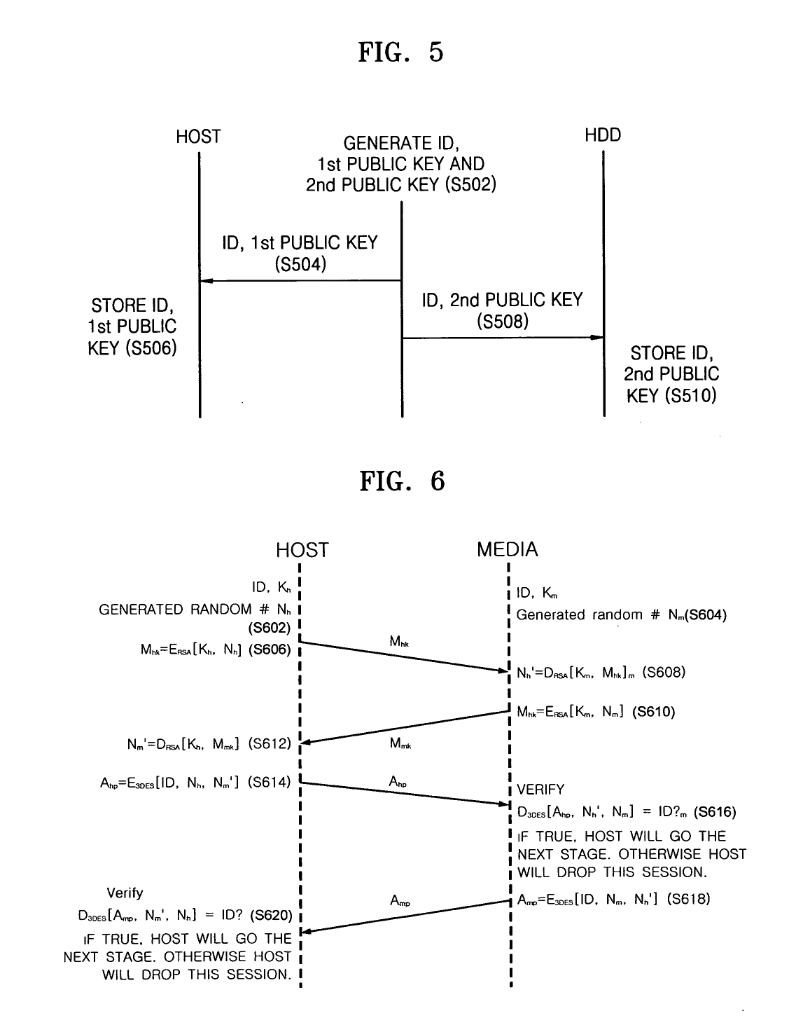

FIG. 5 illustrates allocation of IDs and public key encryption keys used in an authentication method according to the present invention. The allocation process is performed when the recording device connects to the host system for the first time or when the recording device connected to the host system is booted up for the first time.

First, an ID, a first public key of the host system and a second public key of the recording device are generated (S502).

The ID and the first public key are supplied to the host system (S504) and the host system stores the supplied ID and the supplied first public key in a memory (S506). The host system may encrypt the ID and the first public key by an arbitrary encryption method to store the encrypted ID and the first encrypted public key so as to prevent the ID and the first public key from being compromised. The encrypted ID and the first encrypted public key will be decrypted in a proper decryption method to use the original ID and the original first public key for authentication.

The ID and the second public key are supplied to the HDD (S508) and the HDD stores the supplied ID and the supplied first public key on its maintenance cylinder (S510). The maintenance cylinder stores important information to operate the HDD and the information stored on the maintenance cylinder is accessible by the HDD but not by the host system. As in the host system, the HDD may encrypt the ID and the second public key to store the encrypted ID and the second encrypted public key.

FIG. 6 illustrates an authentication method of the present invention. In this embodiment of the present invention, the host system performs authentication at first. Note that, however, the HDD (MEDIA) may perform authentication at first in the same manner.

First, the host system generates a first random number Nₕ (S602) where the first random number Nₕ is generated by a first random number generator of the host system. Then, the HDD generates a second random number Nₘ (S604) where the second random number Nₘ is generated by a second random number generator of the HDD.

The host system encrypts the first random number Nₕ and transmits the first encrypted random number Mₕₖ to the HDD (S606) where the adopted encryption method is a public key encryption method. The first random number Nₕ is encrypted by a first public key Kₕ given to the host system and the first encrypted random number Mₕₖ is generated as the encryption result. The host system transmits the first encrypted random number Mₕₖ to the HDD through an ATA interface.

The HDD decrypts the first encrypted random number Mₕₖ by a second public key Kₘ given to the HDD to obtain a first decrypted random number Nₕ′ (S608). If the second public key Kₘ of the HDD is identical to the first public key Kₕ of the host system, the first decrypted random number Nₕ′ will be identical to the first random number Nₕ. However, if the second public key Kₘ of the HDD is different from the first public key Kₕ of the host system, the first decrypted random number Nₕ′ will be different from the first random number Nₕ.

The HDD encrypts the second random number Nₘ and transmits the second encrypted random number Mₘₖ to the host system (S610) where the adopted encryption method is a public key encryption method. The second random number Nₘ is encrypted by the second public key Kₘ given to the HDD and the second encrypted random number Mₘₖ is generated as the encryption result. The HDD transmits the second encrypted random number Mₘₖ to the host system through the ATA interface.

The host system decrypts the second encrypted random number Mₘₖ by the first public key Kₕ given to the host system to obtain a second decrypted random number Nₘ′ (S612). If the second public key Kₘ of the HDD is identical to the first public key Kₕ of the host system, the second decrypted random number Nₘ′ will be identical to the second random number Nₘ. However, if the second public key Kₘ of the HDD is different from the first public key Kₕ of the host system, the second decrypted random number Nₘ′ will be different from the second random number Nₘ.

The host system encrypts the ID by the first random number Nₕ and the second decrypted random number Nₘ′ and transmits the encrypted ID to the HDD (S614) where the adopted encryption method is the secret key encryption method. Various methods may be used to encrypt the secret key and the most popular DES may be used.

When the general DES is adopted, the host system encrypts the ID by the second decrypted random number Nₘ′ and transmits the encrypted ID to the HDD. Since the second decrypted random number Nₘ′ is generated on the basis of the second random number Nₘ, if the second decrypted random number Nₘ′ is different from the second random number Nₘ, the authentication fails.

The ID may, however, be encrypted using two secret keys to transmit the encrypted ID in 3DES for the sake of more efficient authentication wherein the first random number Nₕ is used as a first secret key and the second decrypted random number Nₘ′ is used as a second secret key.

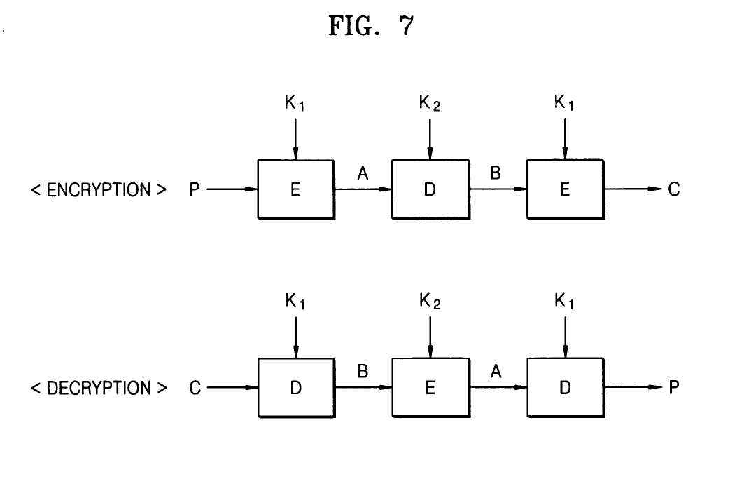

FIG. 7 illustrates triple DES (3DES). Referring to FIG. 7, in an encryption process of 3DES, a transmission statement P is encrypted using two secret keys K_{1 and K}₂. First, the transmission statement P is encrypted using the first secret key K, to obtain a first encrypted statement A, and then the first encrypted statement A is decrypted using the second secret key K₂ to obtain the second encrypted statement B. Finally, the second encrypted statement B is encrypted again using the first secret key K, to obtain a final third encrypted statement C. The third encrypted statement C is generated in the 3DES.

Referring to FIG. 7, in the decryption process of 3DES, the encrypted statement C is decrypted using the two secret keys K₁ and K₂ that were used for encryption. First, the encrypted statement C is decrypted using the first secret key K₁ to obtain the second encrypted statement B, and then the second encrypted statement B is encrypted using the second secret key K₂ to obtain the first encrypted statement A. Finally, the first encrypted statement A is decrypted again using the first secret key K₁ to obtain a final transmission statement P. The transmission statement P is generated in 3DES.

The HDD decrypts the encrypted ID transmitted from the host system using the first decrypted random number Nₕ′ and the second random number Nₘ to obtain a decrypted ID and compares the decrypted ID with its own ID to authenticate the host system (S616) wherein the first decrypted random number Nₕ′ is used as a first secret key and the second random number Nₘ is used as a second secret key.

If the first decrypted random number Nₕ′ of the HDD is identical to the first random number Nₕ of the host system, the decrypted ID is identical to the original ID and the authentication succeeds. If the authentication succeeds, the next authentication is performed.

If the first decrypted random number Nₕ′ of the HDD is different from the first random number Nₕ of the host system, the decrypted ID is different from the original ID. Accordingly, the authentication fails.

When the HDD authenticates the host system, the HDD encrypts the ID by the first decrypted random number Nₕ′ and the second random number Nₘ generated by the HDD to transmit the encrypts ID to the host system (S618). The adopted encryption method is the secret key encryption method as S614. In contrast to the secret key encryption of the host system, the second random number Nₘ is used as the first secret key and the first decrypted random number Nₕ′ is used as the second secret key. If the host system uses the general DES; the HDD may encrypt the ID by the first decrypted random number Nₕ′ in the general DES to transmit the encrypted ID to the host system.

The host system decrypts the encrypted ID transmitted from the HDD using the first random number Nₕ and the second decrypted random number Nₘ′ to obtain a decrypted ID and compares the decrypted ID with its own ID to authenticate the HDD (S620) wherein the second decrypted random number Nₘ′ is used as a first secret key and the first random number Nₕ is used as a second secret key.

If the second decrypted random number Nₘ′ of the host system is identical to the second random number Nₘ of the HDD, the decrypted ID is identical to the ID and the authentication succeeds.

If the second decrypted random number Nₘ′ of the host system is different from the second random number Nₘ of the HDD, the decrypted ID is different from the original ID. Accordingly, the authentication fails.

Before the authentication method shown in FIG. 6, the HDD is set to be in a LOCK state at first. If the state of the HDD is changed from the LOCK state into the UNLOCK state after the authentication fails, all the information on the HDD may be deleted to prevent the information from being compromised.

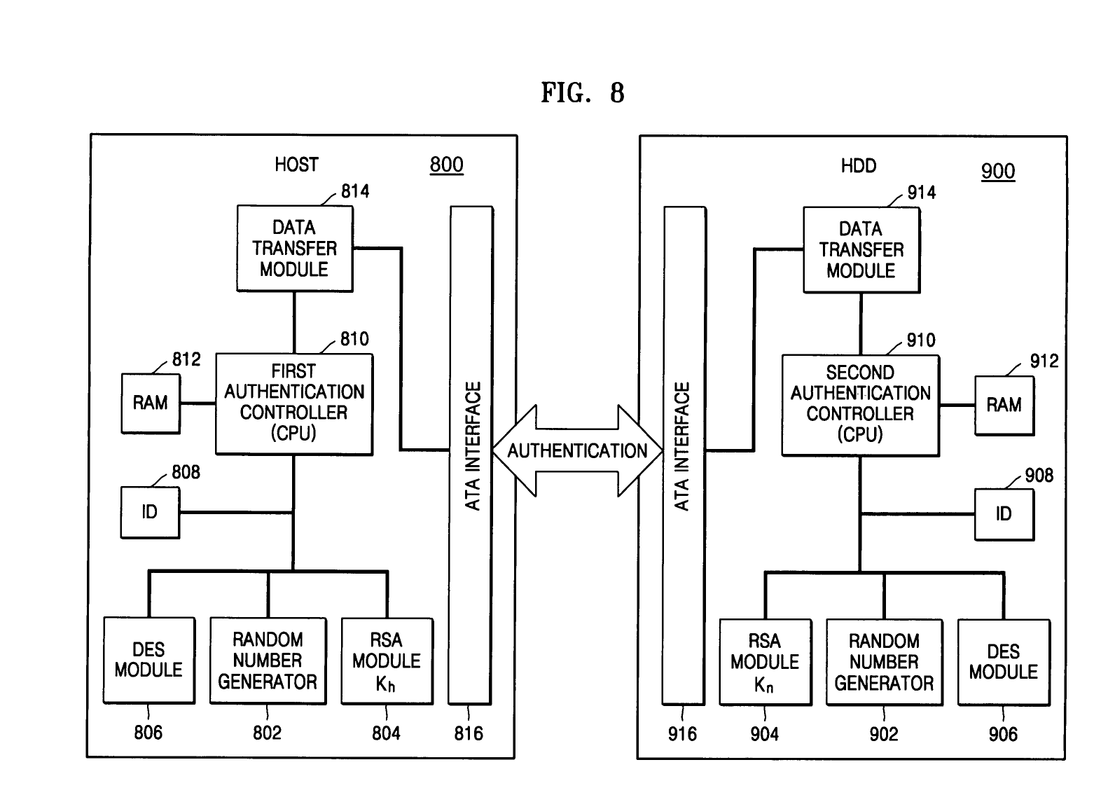

FIG. 8 is a block diagram illustrating an authentication apparatus according to the present invention. The authentication apparatus comprises a first authentication apparatus 800 on the side of the host system and a second authentication apparatus 900 on the side of the HDD.

The first authentication apparatus 800 comprises a first random number generator 802, a first public key encryptor 804, a first secret key encryptor 806, a first memory 808 and a first authentication controller 810. The first random number generator 802 generates a first random number. The first public key encryptor 804 encrypts the first random number by a first public key allocated to the host system and/or decrypts an encrypted second random number supplied from the HDD. The first secret key encryptor 806 encrypts a common ID for the host system and the recording device by the first random number and the decrypted second random number and/or decrypts an encrypted ID transmitted from the HDD. The first memory 808 stores the ID allocated to the host system. The first authentication controller 810 controls the first random number generator 802 and the first public key encryptor 804 to generate and encrypt the first random number and transmit the encrypted first random number to the HDD through a data transmission module 814 at the HDD's request for an access, if the encrypted second random number is transmitted from the HDD, then controls the first public key encryptor 804 to decrypt the encrypted second random number and controls the first secret key encryptor 806 to generate an encrypted ID and transmit the encrypted ID to the HDD through a data transmission module 814, if the encrypted ID is transmitted from the HDD, then controls the first secret key encryptor 806 to decrypt the encrypted ID, and if the decrypted ID is identical to the original allocated ID, then authenticates the HDD.

The first authentication controller 810 may include a central processing unit (hereinafter, referred to as CPU), a microprocessor, a digital signal processor and the like, and is provided with a RAM 812 so as to store a program and data to control the first authentication controller 810.

The second authentication apparatus 900 comprises a second random number generator 902, a second public key encryptor 904, a second secret key encryptor 906, a second memory 908 and a second authentication controller 910. The second random number generator 902 generates the second random number. The second public key encryptor 904 encrypts the second random number by a second public key allocated to the HDD and/or decrypts the encrypted first random number supplied from the host system. The second secret key encryptor 906 encrypts the common ID for the host system and the recording device by the second random number and the decrypted first random number and/or decrypts the encrypted ID transmitted from the host system. The second memory 908 stores the ID allocated to the HDD and may be a maintenance cylinder of the HDD. The second authentication controller 910 controls the second random number generator 902 and the second public key encryptor 904 to generate and encrypt the second random number and transmit the encrypted second random number to the host system through a data transmission module 914 at the host system request for an authentication, if the encrypted first random number is transmitted from the host system, then controls the second public key encryptor 904 to decrypt the encrypted first random number and controls the second secret key encryptor 906 to generate an encrypted ID and transmit the encrypted ID to the host system through a data transmission module 914, if the encrypted ID is transmitted from the host system, then controls the second secret key encryptor 906 to decrypt the encrypted ID, and if the decrypted ID is identical to the original allocated ID, then authenticates the host system.

The second authentication controller 910 may include a CPU, a microprocessor, a digital signal processor and the like, and is provided with a RAM 912 so as to store a program and data to control the first authentication controller 910.

The data transmission modules 814 and 914 transmit data in an ATAPI method.

The STB shown in FIG. 8 allows the VOD service data to be recorded on the HDD and allows the VOD service data recorded on the HDD to be replayed only if the host system and the HDD successfully authenticate each other.

If one of the host system and the HDD fails to authenticate the other, the STB does not allow the VOD service data to be recorded on the HDD and does not allow the VOD service data recorded on the HDD to be replayed. Accordingly, an illegal HDD is not allowed to store the VOD service data and the VOD service data recorded on the illegal HDD cannot be replayed.

Similarly, the VOD service data are allowed to be recorded on the HDD and the VOD service data recorded on the HDD can be replayed only if the host system and the HDD successfully authenticate each other.

If one of the host system and the HDD fails to authenticate the other, the HDD does not allow the VOD service data to be recorded thereon and does not allow the VOD service data recorded thereon to be replayed. Accordingly, an illegal host system is not allowed to store nor replay the VOD service data.

The authentication times of the authentication apparatuses of FIG. 8 may be various. For example, the authentication may be performed before a recording session or a replay session, or during an initialization process after the STB is turned on.

It is efficient that the authentication apparatuses of FIG. 8 perform the authentication before the recording session or the replay session before the recording session or the replay session but it is more efficient that the authentication apparatuses perform the authentication once during the initialization process, considering that the HDD cannot be removed after the STB begins to be operated.

The present invention may be carried out in the form of a method, a device and a system. When the present invention is carried out in the form of software, the elements of the present invention are essential code segments which perform necessary tasks. The program and code segments may be stored on a processor readable medium and transmitted in the form of a computer data signal coupled with a carrier wave in transmission media or communication network. The processor readable medium may be any medium through which information can be stored or transmitted. Examples of the processor readable medium include electronic circuit, semiconductor memory device, read-only memory (ROM), flash memory, erasable ROM (EROM), floppy disks, optical data storage devices, hard disks, optical fiber medium, radio frequency network, and the like. The computer data signal may be any signal that may be transmitted through transmission medium such as electronic network channel, optical fiber, air, electromagnetic field, radio frequency network, and the like.

According to the authentication method of the present invention, in a data processing apparatus with a recording device which may store data, as long as a host system and the recording device authenticate each other, the recording device is allowed to be accessed, in other words, the data may be stored on the recording device or the data stored on the recording device may be replayed so that an illegal user is prevented from illegally using the data.

According to the authentication method of the present invention, in encrypting IDs using a first random number generated by the host system and a second random number generated by the recording device, since the random numbers are changed whenever the recording device is authenticated, even if data transmitted between the host system and the recording device is read out between the host system and the recording device, the IDs is prevented from being compromised.

According to the authentication method of the present invention, since it is possible to record data on only the authenticated recording device and replay only the data recorded on the authenticated recording device, it is impossible to remove the authenticated recording device from the data processing apparatus and use the data recorded on the authenticated recording device or to substitute another unauthenticated recording device for the authenticated recording device in the data processing apparatus to replay the data recorded on the unauthenticated recording device. Accordingly, the contents are prevented from being illegally used.

Although a few embodiments of the present invention have been shown and described, it would be appreciated by those skilled in the art that changes may be made in this embodiment without departing from the principles and spirit of the invention, the scope of which is defined in the claims and their equivalents.

1. An method of authenticating a host system and a data processing apparatus, the host system processing data, the data processing apparatus being provided with a recording device which accesses to the host system, the method comprising:
generating a first random number and a second random number at the host system and the recording device respectively;
transmitting the first and second random numbers from the host system and the recording device to the recording device and the host system, respectively;
encrypting a common ID (identifier) for the host system and the recording device by the first random number at the host system to transmit the encrypted ID to the recording device;
encrypting the common ID by the second random number at the recording device to transmit the encrypted ID to the host system;
decrypting the encrypted ID transmitted from the recording device at the host system;
decrypting the encrypted ID transmitted from the host system at the recording device;
comparing the common ID decrypted by the host system with the common ID of the host system to check whether the decrypted ID is identical to the common ID of the host system;
comparing the common ID decrypted by the recording device with the common ID of the recording device to check whether the decrypted ID is identical to the common ID of the recording device;
if the common ID decrypted by the host system is identical to the common ID of the host system, authenticating the recording device at the host system; and
if the common ID decrypted by the recording device is identical to the common ID of the recording device, authenticating the host system at the recording device.

2. The method of claim 1, further comprising:
encrypting the first and second random numbers by first and second public keys allocated to the host system and the recording device, respectively.

3. The method of claim 1, wherein the encrypting of the common ID for the host system and the recording device by the first and second random numbers at the host system and the recording device, respectively, further comprises:
encrypting the common ID by decrypting the second and first encrypted random numbers at the host system and the recording devices, respectively.

4. The method of claim 3, wherein the encrypting of the common ID further comprises:
encrypting the common ID in DES encryption.

5. The method of claim 1, wherein the encrypting of the common ID for the host system and the recording device by the first and second random numbers at the host system and the recording device, respectively, further comprises:
encrypting the common ID using the first and second random numbers generated by the host system and the recording device, respectively; and
decrypting the second and first encrypted random numbers at the host system and the recording devices, respectively.

6. The method of claim 5, wherein the encrypting of the common ID further comprises:
encrypting the common ID in 3DES (triple DES) encryption.

7. The method of claim 1, further comprising:
setting the recording device to be in a LOCK state before authentication; and
if the authentication fails, changing the recording device to an UNLOCK state and deleting data stored in the recording device.

8. An authentication system of a host system and a data processing apparatus, the host system processing data, the data processing apparatus being provided with a recording device which accesses the host system, the authentication system comprising:
a first authentication apparatus provided in the host system and comprising a first random number generator which generates a first random number, a first secret key encryptor and a first authentication controller; and
a second authentication apparatus provided in the recording device and comprising a second random number generator which generates a second random number, a second secret key encryptor and a second authentication controller,
wherein:
the first secret key encryptor encrypts a common ID for the host system and the recording device by at least one of the first random number and the second random number and/or decrypts a first encrypted ID transmitted from the recording device by the at least one of the first random number and the second random number;
the first authentication controller controls the first random number generator to generate the first random number and transmit the first random number to the recording device in response to a request for an access by the recording device, if the second random number is transmitted from the recording device to the host system, then controls the first secret key encryptor to generate a second encrypted ID and transmit the second encrypted ID to the recording device, if the first encrypted ID is transmitted from the recording device, then controls the first secret key encryptor to decrypt the first encrypted ID, and if the decrypted first encrypted ID is identical to the common ID, then authenticates the recording device;
the second secret key encryptor encrypts the common ID for the host system and the recording device by at least one of the first random number and the second random number and/or decrypts the second encrypted ID transmitted from the host system to the recording device by the at least one of the first random number and the second random number; and
the second authentication controller controls the second random number generator to generate the second random number and transmit the second random number to the host system in response to a request for an authentication by the host system, if the first random number is transmitted from the host system, then controls the second secret key encryptor to generate the first encrypted ID and transmit the first encrypted ID to the host system, if the second encrypted ID is transmitted from the host system, then controls the second secret key encryptor to decrypt the second encrypted ID, and if the decrypted second encrypted ID is identical to the common ID, then authenticates the host system.

9. The system of claim 8, wherein:
the first authentication apparatus further comprises a first public key encryptor which encrypts the first random number by a first public key allocated to the host system, to transmit the first random number to the recording device; and
the second authentication apparatus further comprises a second public key encryptor which encrypts the second random number by a second public key allocated to the recoding device to transmit the second random number to the host system.

10. The system of claim 9, wherein the first and second public key encryptors encrypt the first and the second random numbers in an RSA method.

11. The system of claim 8, wherein:
the first secret key encryptor obtains the second random number to encrypt the common ID by decrypting an encrypted second random number transmitted from the second authentication apparatus; and
the second secret key encryptor obtains the first random number to encrypt the common ID by decrypting an encrypted first random number transmitted from the first authentication apparatus.

12. The system of claim 11, wherein the first and second secret key encryptors encrypt the common ID in DES encryption.

13. The system of claim 8, wherein the first secret key encryptor encrypts the common ID by the first random number and a second decrypted random number obtained by decrypting the second encrypted random number transmitted from the second authentication apparatus; and
the second secret key encryptor encrypts the common ID by the second random number and a first decrypted random number obtained by decrypting the first encrypted random number transmitted from the first authentication apparatus.

14. The system of claim 13, wherein the first and second secret key encryptors encrypt the common ID in 3DES encryption.

15. A computer readable recording medium storing a program for a method of authenticating a host system and a data processing apparatus, the host system processing data, the data processing apparatus being provided with a recording device which accesses the host system, wherein the program comprises instructions for:
generating a first random number and a second random number at the host system and the recording device respectively;
transmitting the first and second random numbers from the host system and the recording device to the recording device and the host system, respectively;
encrypting a common ID for the host system and the recording device by the first random number at the host system to transmit the encrypted ID to the recording devices, and encrypting the common ID by the second random number at the recording device to transmit the encrypted ID to the host system;
decrypting the encrypted ID transmitted from the recording device at the host system;
decrypting the encrypted ID transmitted from the host system at the recording devices;
comparing the common ID decrypted by the host system with the common ID of the host system to check whether the decrypted ID is identical to the common ID of the host system;
comparing the common ID decrypted by the recording device with the common ID of the recording device to check whether the decrypted ID is identical to the common ID of the recording devices;
authenticating the recording device at the host system, if the common ID decrypted by the host system is identical to the common ID of the host system; and
authenticating the host system at the recording devices, if the common ID decrypted by the recording devices is identical to the common ID of the recording device.

16. A method of authenticating a host system and a data processing apparatus, the host system processing data, the data processing apparatus being provided with a recording device which accesses to the host system, the method comprising:
encrypting a common ID for the host system and the recording device by a random number transmitted by the host system to transmit the encrypted ID to the host system;
decrypting the encrypted ID transmitted from the recording device;
comparing the decrypted ID with the common ID of the host system to check whether the decrypted ID is identical to the common ID of the host system; and
if the decrypted ID is identical to the common ID of the host system, authenticating the recording device.

17. The method of claim 16, further comprising:
encrypting the random number by a public key allocated to the host system, to transmit the random number to the recording device.

18. A method of authenticating a host system and a data processing apparatus, the host system processing data, the data processing apparatus being provided with a recording device which accesses to the host system, the method comprising:
encrypting a common ID for the host system and the recording device by a random number transmitted by the recording device to transmit the encrypted ID to the recording device;
decrypting the encrypted ID transmitted from the host system;
comparing the decrypted ID with the common ID of the recording device to check whether the decrypted ID is identical to the common ID of the recording device; and
if the decrypted ID is identical to the common ID of the recording device, authenticating the host system.

19. The method of claim 18, further comprising:
encrypting the random number by a public key allocated to the recording device.

20. An apparatus provided in a host system for authenticating access of a recording device in a data processing apparatus to data of the host system, the apparatus comprising:
a random number generator;
a secret key encryptor/decryptor; and
an authentication controller which:
controls the random number generator to generate a first random number,
transmits the first random number to the recording device in response to an access request by the recording device
controls the secret key encryptor/decryptor to encrypt a first ID by the first random number and a second random number provided by the recording device and transmits the encrypted first ID to the recording device,
controls the secret key encryptor/decryptor to decrypt an encrypted second ID transmitted from the recording device by the first and second random numbers, and
authenticates the recording device, if the decrypted second ID is identical to the first ID.

21. An authentication apparatus provided in a recording device for authenticating access to data of a host system, the authentication apparatus comprising:
a random number generator;
a second secret key encryptor/decryptor; and
an authentication controller which:
controls the random number generator to generate a first random number and transmit the first random number to the host system in response an authentication request by the host system,
controls the secret key encryptor/decryptor to encrypt a first ID by the first random number and a second random number provided by the host system and to transmit the encrypted first ID to the host system,
controls the secret key encryptor/decryptor to decrypt an encrypted second ID transmitted by the host system by the first and second random numbers, and
authenticates the host system, if the decrypted second ID is identical to the first ID.

22. A method of authenticating access of a data recording device to data provided by a host system, the host system having a corresponding first ID and the data recording device having a corresponding second ID, the method comprising:
storing a first value corresponding to the second ID in the host system and storing a second value corresponding to the first ID in the recording device;
generating first and second random numbers in the host system and the recording device, respectively;
transmitting the first random number to the recording device and the second random number to the host system;
encrypting each of the first ID and the second ID by the first and second random numbers and transmitting the encrypted first ID and the encrypted second ID to the recording device and the host system, respectively;
decrypting the encrypted first ID at the recording device and the encrypted second ID at the host system;
authenticating the recording device at the host system if the decrypted second ID equals the first value; and
authenticating the host system at the recording device if the decrypted first ID equals the second value.

23. The method of claim 21, wherein the encrypting of each of the first ID and the second ID further comprises:
encrypting the first ID and the second ID using DES encryption.

24. The method of claim 21, wherein the encrypting of each of the first ID and the second ID further comprises:
encrypting the first ID and the second ID using triple DES encryption.

25. The method of claim 21, wherein the transmitting of the first and second random numbers comprises:
encrypting the first and second random numbers according to a public key prior to the transmitting of the first and second random numbers; and
decrypting the first and second random numbers after the transmitting of the first and second random numbers according to the public key.

26. A method of controlling access to data obtained from a host system by a reproducing apparatus and recorded on a recording device of the reproducing apparatus, the method comprising:
mutually authenticating the host system and the recording device to each other at a predetermined time prior to reproducing the recorded data; and
permitting access of the reproducing apparatus to the data recorded on the recording device only if the mutual authentication is successful.

27. The method of claim 26, wherein the mutual authenticating comprises:
exchanging and decrypting encrypted expressions corresponding to respective identifications of the host system and the data recording device; and
verifying that the decrypted expression at each of the host system and the data recording device corresponds to the respective identification of the other one of the host system and the recording device.

28. The method of claim 26, further comprising:
deleting the data recorded on the recording device if the mutual authentication is not successful.
